(19) United States
(12) Patent Application Publication
(10) Pub. No.: US 2018/0014585 A1
(43) Pub. Date: Jan. 18, 2018

(54) Temperature controlled garment

(71) Applicants: DAVID REQUENA POLONIO, CORDOBA (ES); FRANCISCO JAVIER NAVAS MARTOS, CORDOBA (ES)

(72) Inventors: DAVID REQUENA POLONIO, CORDOBA (ES); FRANCISCO JAVIER NAVAS MARTOS, CORDOBA (ES)

(21) Appl. No.: 15/650,841

(22) Filed: Jul. 14, 2017

Related U.S. Application Data
(60) Provisional application No. 62/363,294, filed on Jul. 17, 2016.

(51) Int. Cl. A41D 13/005; A41D 31/02; A41D 27/00; A41D 31/00; G01K 13/00; G01K 1/02

(52) U.S. Cl. CPC A41D 13/005; G01K 13/002; G01K 1/024; A41D 27/00; A41D 31/0033; A41D 31/02

(57) ABSTRACT

The invention discloses a temperature controlled garment (1) comprising temperature controlled multilayer portions (2) attached to a garment fabric (3), where each said temperature controlled multilayer portion (2) comprises: a thermoelectric device (4) having an inner planar side (4a) and an outer planar side (4b); a thermally conductive flexible outer layer (5) welded to the outer planar side (4b) of the thermoelectric device (4); and a thermally conductive flexible inner layer (6) welded to the inner planar side (4a) of the thermoelectric device (4).

### PRIOR APPLICATION

The present invention is a nonprovisional of, and claims the benefit of, U.S. Provisional Patent Application No. 62/363,294, filed Jul. 17, 2016, entitled “SMART CLOTHES TO CONTROL AND GRADUATE THE BODY TEMPERATURE USING WIRELESS COMMUNICATION”, the subject matter of which is incorporated by reference herein in its entirety.

### OBJECT OF THE INVENTION

The present invention relates generally to the field of wearable technology for providing personalized cooling or heating to an individual.

The object of the present invention is a novel garment having temperature control means, such that the person wearing the garment is selectively kept cool or warm.

### PRIOR ART

The human body must maintain an average temperature of 37 degrees Celsius but the ambient temperature around us is often unpredictable. We live with constant changes in the temperature around us but we cannot keep ourselves at the optimum temperature at all times.

More recently, there have been attempts to use thermoelectric devices to provide personal cooling and/or heating. Thermoelectric devices, which may also be called Peltier devices, TEM devices, thermo-voltaic modules, thermoelectric cooler, and so on, use the Peltier effect to create a heat flux between the junction of two different types of materials. A Peltier-based device is a solid-state active heat pump that transfers heat from one side of the device to the other against a temperature gradient (e.g., from cold to hot) when powered by an electric source (e.g., with consumption of electrical energy). Simply connecting a thermoelectric device to a DC voltage such as a battery or other power source will cause one side to cool while the other side of the device to warm.

To date, thermoelectric devices have not been widely adopted for personal temperature control or regulation. One of the problems with previously proposed designs is that Peltier devices required relatively large voltages and high currents to be useful, and even at higher voltages and currents (such as 15 VDC and up to 5 amps or the like) the devices often could only provide a few degree temperature reduction. Some lower voltage Peltier devices have been developed that can create larger temperature differences relative to ambient, but these devices still have not been widely adopted for personal use. Another problem with prior devices is that heat transfer from the body of the user to the Peltier device has been inefficient and/or uncomfortable for the user.

For example, some proposed devices have used a metal plate as a heat transfer element. The metal plate has one side mated to the Peltier device and a second side positioned near the body of the user (such as against the user's skin) to attempt to remove heat from the user's body to the Peltier device. One known design discloses the metal heat transfer element provided in a heat band, but the rigidness of the element makes the device uncomfortable to wear and also provides limited heat transfer surface area. For example, the rigidness of the metal causes the band to only contact the user's head at “high” points or areas, which significantly reduces the heat transfer surface area and also creates pressure points that leads to user discomfort. As a result, such designs are limited to use with smooth and/or flat portions of the user's body to try to increase the area in contact with the skin. Pads may be provided between the heat transfer element and the user's skin to increase comfort, but such a pad lowers the heat transfer rate from the skin to the heat transfer element. Further, these devices are cumbersome, uncomfortable, and not very appealing from a design point of view.

Therefore, there is a need in the art for a comfortable wearable system capable of controlling body temperature by providing a complete cool and warm sensation using thermoelectric technology integrated in any kind of garment without negatively affecting the design of the garment.

### DESCRIPTION OF THE INVENTION

In the present document, the term “garment” refers to any piece of clothing any user may wear, including, without limitation, shirts, jackets, T-shirts, trousers, socks, shoes, hats, caps, gloves, wristbands, etc.

In the present document, the term “garment fabric” refers to the main piece, or pieces, of fabric making up the garment, excluding the additional devices, layers and fabrics making up the temperature controlled multilayer portions attached thereto. The garment fabric may include any kind of fabric, either woven or non-woven, as well as any type of material such as, without limitation, cotton, polyester, wool, etc.

In the present document, the terms “inwards” and “outwards” should be interpreted in connection with an essentially perpendicular direction with respect to the skin of the user (or correspondingly to the garment fabric). More specifically, the term “inwards” refers to a direction towards the skin of the user, and the term “outwards” refers to a direction towards the environment (i.e. a direction opposite the skin of the user).

The present invention solves the aforementioned drawbacks by means of a temperature controlled garment comprising temperature controlled multilayer portions attached to a garment fabric, where each temperature controlled multilayer portion comprises:
a) A thermoelectric device
Each temperature controlled multilayer portion comprises a thermoelectric device having an inner planar side and an outer planar side.
A thermoelectric device is basically a solid state active heat pump based on the Peltier effect capable of transferring heat from one side of the device to the other when supplied with electrical energy. The heat transfer direction is dependent of the direction of the current, and therefore on the polarity of the voltage applied to the device. The present invention may use a thermoelectric device having a generally planar configuration with two main planar sides. Thermoelectric devices are presently rigid, but the present invention also foresees the use of flexible thermoelectric devices in a near future.
As disclosed in more detail below in the present document, the thermoelectric device is positioned such that, when the user wears the garment of the invention, an inner planar side thereof faces the user skin, and an outer planar side thereof faces the environment. With this configuration, when supplied with electrical power, the inner planar side gets hot (alternatively cold) and thus conveys heat to (alternatively takes away heat from) the skin of the user. At the same time, the outer planar side gets cold (alternatively hot), thus absorbing heat from the environment (alternatively emitting heat to the environment).
Now, the temperature generated at the outer planar side must be kept away from the skin of the user. That is, in case of providing a warm feeling to the user by heating the inner planar side, it is important to ensure that the correspondingly cold outer planar side doesn't take away part of the heat generated at the inner planar side. Conversely, in the case of cooling the user, it is important to ensure that the correspondingly hot outer planar side doesn't convey heat towards the cold inner planar side. These problems are solved by providing the thermally conductive outer/inner layers disclosed below.
b) A thermally conductive flexible outer layer
Each temperature controlled multilayer portion also comprises a thermally conductive flexible outer layer welded to the outer planar side of the thermoelectric device. The thermally conductive flexible outer layer can be made in any material e.g. tin or brass provided it is flexible, resistant to rust, and it has a high thermal conductivity. In this context, a high thermal conductivity is any conductivity above 2 W/mK.
The thermally conductive outer layer conveys the temperature generated at the outer planar side of the thermoelectric device towards the environment. In order to do so, it is fixed to the outer planar side of the thermoelectric device by welding, which is the most heat conductive suitable connection method. Indeed, it is known that welding promotes heat transfer by conduction through the welding material. As a welding material, brass having a thermal conductivity of 50 W/mK could be employed for welding the thermally conductive outer layer to the outer planar side of the thermoelectric device. In contrast, known thermal adhesives generally employed for this purpose have a thermal conductivity of 1.2 W/mK. In any case, any welding material having a high thermal conductivity and resistant to rust could be employed, e.g. tin or brass.
Further, the inventors of the present application have found that using a thermally conductive outer layer being a fabric comprising yarns made of a thermally conductive material is particularly advantageous. Indeed, as disclosed above, the temperature generated at the outer planar side of the thermoelectric device is first conveyed towards the thermally conductive outer layer by conduction through the welded connection, and thereafter it must be conveyed towards the environment. A fabric made of thermally conductive yarns allowing the passage of air therethrough promotes heat transfer towards the surrounding air by convection. The environment therefore more rapidly takes away the heat from the thermally conductive outer layer when hot, or heats the thermally conductive outer layer when cold. Further, the use of a fabric is further advantageous because it is flexible for adapting to the shape of the body of the user at the place where the relevant temperature controlled multilayer portion is located.
In a particularly preferred embodiment, the thermally conductive outer layer is a tinned copper thermal fabric. A tinned copper thermal fabric is made by copper yarns coated with a thin layer of tin. Tinned copper fabric or strap is not only known to have very good conduction transfer capabilities, but it is also easily welded to the outer planar side of the thermoelectric device.
c) A thermally conductive flexible inner layer
Each temperature controlled multilayer portion comprises also comprises a thermally conductive inner layer welded to the inner planar side of the thermoelectric device. The thermally conductive flexible inner layer can be made in any material e.g. tin or brass provided it is flexible, resistant to rust, and it has a high thermal conductivity. As mentioned earlier, a high thermal conductivity is any conductivity above 2 W/mK.
The thermally conductive inner layer conveys the temperature generated at the inner planar side of the thermoelectric device towards the skin of the user. In order to do so, it is fixed to the inner planar side of the thermoelectric device by welding, preferably using a material such as tin or brass as a welding material, for the same reasons explained in connection with the thermally conductive outer layer.
Furthermore, the inventors of the present application have found that heat transfer in this inner side of the garment takes place mainly by conduction. Convection doesn't play a relevant role here. Therefore, the thermally conductive inner layer needs not be a fabric allowing the passage of air therethrough, as the thermally conductive outer layer. In contrast, the thermally conductive inner layer is preferably a flexible foil made of a thermally conductive material. A flexible foil adapts to the shape of the body of the user at the place where the relevant temperature controlled multilayer portion is located. Since the thermally conductive inner layer is the innermost layer of the multilayer portion, the contact area with the skin of the user is thereby maximum, promoting the transfer of heat to/from the skin of the user.
In a further preferred embodiment of the invention, the thermally conductive inner layer is a tinned copper flexible foil. Tinned copper foil comprises a copper foil coated by a thin layer of tin. However, note that other materials e.g. tin or brass having a high thermal conductivity and being resistant to rust could be employed.

The temperature controlled garment disclosed above allows for maintaining a user warm or cold irrespective of the outside environment temperature. When the user desires to be warmed, the thermoelectric device is actuated such that the inner planar side thereof gets hot and the outer planar side thereof gets cold. The heat generated at the inner planar side of the thermoelectric device naturally transfers inwards by conduction through the highly conductive welded connection towards the thermally conductive flexible inner layer. The thermally conductive flexible inner layer is in close contact with the skin of the user, who immediately feels a warm feeling. At the same time, the outer planar side of the thermoelectric device gets cold. Heat from the environment air transfers inwards, first by convection of the air passing through the fabric yarns making up the thermally conductive flexible outer layer, and thereafter by conduction through the highly conductive welded connection between the thermally conductive flexible outer layer and the outer planar side of the thermoelectric device. A similar process takes place when the device is actuated such that the inner planar side thereof gets cold and the outer planar side thereof gets hot, the heat being then transferred in the opposite direction.

In a further preferred embodiment of the invention, a surface of the thermally conductive flexible outer layer and the thermally conductive flexible inner layer is larger than a surface of the thermoelectric device. Indeed, note that thermoelectric devices are usually rectangular with standard sizes ranging from a few millimeters, for example 1 or 2 millimeters, to a few centimeters, for example 3 or 4 centimeters. Therefore, in order to enlarge the thermal conduction surface area of each temperature controlled multilayer portion, the thermally conductive flexible outer and inner layers thereof may be considerably larger than the thermoelectric device. The temperature generated at the thermoelectric device is thus first transferred to the thermally conductive flexible outer and inner layers, it spreads around them, and is transferred respectively towards the environment and the skin of the user.

In another preferred embodiment of the invention, the garment further comprises a thermally insulating intermediate layer provided between the thermally conductive outer layer and the thermally conductive inner layer in an area of the temperature controlled multilayer portions not occupied by the thermoelectric device. Indeed, the thermally conductive inner and outer layers should not be in direct contact, since in use one is warm and the other is cold. Therefore, in the area between the inner and outer layers of the temperature controlled multilayer portions where the thermoelectric device is not present, a thermally insulating intermediate layer is provided. This thermally insulating layer ensures that the temperature conveyed to the thermally conductive outer layer is transferred outwards and the temperature conveyed to the thermally conductive inner layer is transferred inwards.

The thermally insulating intermediate layer is made of a material having a low thermal conductivity. In this context, a material having a low thermal conductivity is any material having a thermal conductivity below 0.05 W/mK. Any material having such low thermal conductivity, being flexible and resistant to rust could be employed for the thermally insulating intermediate layer. For example, the thermally insulating intermediate layer can be made of polyethylene (e.g. polyethylene foam, alveolar polyethylene film), polyesthyrene (e.g. expanded poyesthyrene), polyurethane (e.g. polyurethane foam), cellulose (e.g. cellulose foam), neoprene, phenolic resin, etc. In a particularly preferred embodiment of the invention, the thermally insulating intermediate layer further comprises a surface adhesive in both sides for adhering it to the outer thermally insulating layer and the inner thermally insulating layer.

In a further preferred embodiment of the invention, the thermally conductive outer layer of each temperature controlled multilayer portion is attached to an inner surface of the garment fabric. In other words, each temperature controlled multilayer portion is attached to the garment fabric through the thermally conductive outer layer. This connection may take place by any suitable method, such as sewing, knitting, adhesives, or the like.

The thermoelectric device is supplied with electrical energy by any suitable power supply means. In a preferred embodiment, solar panels attached to the garment may be employed for this purpose. Alternatively, the garment could have one or more batteries integrated in the garment fabric or connected thereto. The batteries could be rechargeable with the movement of the user. Obviously, in any of these cases a lead would connect the battery or solar panels with the thermoelectric devices.

Alternatively, in another preferred embodiment of the invention, the garment comprises a first lead electrically connecting the thermoelectric devices with first electrical connection means, where the first electrical connection means protrude outwards through the garment fabric for electrical connection with a power supply means. More preferably, the first lead is attached to an inner side of the garment fabric, traveling along the garment for providing a parallel connection between each thermoelectric device and the first electrical connection means. An external power supply means can thus be connected to the first electrical connection means for providing an electric power to each of the thermoelectric devices.

A further preferred embodiment of the invention discloses a garment comprising a second lead electrically connecting at least a temperature sensor in thermal contact with the thermally conductive inner layer with second electrical connection means, where the second electrical connection means protrude outwards through the garment fabric for electrical connection with a processing means connected with the power supply means. Indeed, the temperature sensor senses the temperature of the thermally conductive inner layer, which is in direct contact with the skin of the user, and therefore allows for a temperature control thereof. Alternatively, the temperature sensor could be provided adjacent the skin of the user such that the temperature of the thermoelectric devices can be controlled taking into account the temperature of the skin. The signal generated by the temperature sensor is carried by the second lead, which is also preferably attached to an inner side of the garment fabric, towards the second electrical connection means with the processing means. The processing means is configured for deciding whether the temperature is too high or too low, and for commanding the power supply means in order to control the voltage supplied to the thermoelectric devices.

The first and second leads are preferable embodied as flexible flat cables. Ribbon-like first and second leads attached to the inner side of the garment fabric therefore connect each thermoelectric device and the temperature sensor with the respective first and second electrical connection means. The extremely flat shape and the flexibility of the flexible flat cables does not affect the usability of the garment. Further, the flat cables could be coated with a waterproof material, e.g. a plastic material.

The first and second electrical connection means protrude outwards through the garment fabric. That means that the garment fabric has holes therein for the passage of the first and second electrical connection means. In principle, the first and second electrical connection means could be configured in any way allowing suitable for connection with mating connectors of the power supply means and the processing means. For example, connection pins or sockets could be employed.

In a particularly preferred embodiment of the invention, the first and second electrical connection means are provided with coupling means configured for coupling to a casing containing the power supply means and the processing means. The casing could be embodied as a lightweight casing containing the power supply means and the processing means connected thereto. Therefore, the garment could be used as a regular garment for a particular period of time. Thereafter, when the user needs to feel warmer or colder, he/she connects the casing to the connection means of the garment. The thermoelectric device is thus supplied with a suitable voltage. The casing would also have selection means for selecting between heating or cooling (i.e. means for selecting the polarity of the power supply means output voltage), as well as temperature selection means for selecting a desired temperature (i.e. means for selecting the voltage level of the power supply means output voltage). The selection means would possibly be incorporated in the processing means.

In another preferred embodiment, the first and second electrical connection means are located in an area of the garment other than in the temperature controlled multilayer portions. This feature is important in that otherwise the casing containing the power supply means and the processing means would be located on the outer surface of a temperature controlled multilayer portion which, during use, becomes warm or cold. Temperature changes, specially hot temperatures, would be prejudicial to the life of the processing means and the power supply means. Further, with this configuration the first and second connection means protruding outwards through the garment fabric do not have to pierce also the thermally conductive flexible outer layer.

In still one more preferred embodiment of the invention, the first and second connection means having coupling means are respective pairs of connectors made of a magnetic and electrically conductive material configured for coupling to magnetically mating and electrically conductive connectors provided in the casing. The first and second connection means therefore fulfill a double function: firstly, the electrically connect the thermoelectric devices with the power supply means and the temperature sensor with the processing means;

secondly, they provide for a fast and convenient magnetic coupling of the casing. For example, the connectors could be embodied as magnetic metal pads configured for being coupled to mating metal pads provided on a backside of the casing. The mating metal pads are, of course, respectively connected to the output of the power supply means and an input of the processing means. This way, the mechanical coupling of the casing to the garment and the electrical connection of the power supply means and the processing means to the thermoelectric devices and the temperature sensor are carried out simultaneously in a single step.

In still a further preferred embodiment, the garment of the invention comprises communication means provided in the casing and connected with the processing means for receiving commands in connection with the voltage and polarity applied to the thermoelectric devices. The communication means could be of any type, either wired or more preferably wireless, most preferably Wifi or Bluetooth means. Thus, any suitable external device, such as e.g. a computer, a tablet, or most preferably a smartphone or a smartwatch, could communicate with the processing means for controlling the temperature control mode (heating/cooling) and for establishing a specific desired temperature. A dedicated application in the smartphone could allow the user to carry out these tasks. Alternatively, or in combination, a control panel for the same purpose could be integrated in the garment.

In a still further preferred embodiment, the garment comprises groups of thermoelectric devices connected by corresponding leads to corresponding input connectors of the power supply means. Therefore, the processing means could control de power supply means such that different voltages are applied to different groups of thermoelectric devices. Each group of thermoelectric devices would then provide a different temperature to the user.

Future developments include the possibility of having very large flexible thermoelectric devices. In that case, the whole or a substantial portion of the garment of the invention could be a thermoelectric device.

Further, thermally conductor fabrics are envisioned in the near future. Such a fabric could be employed in the garment of the invention. In that case, at least the thermally conductive outer layer could be dispensed with.

Even further, the garment of the invention could be submersible.

### DESCRIPTION OF THE FIGURES

The accompanying figures, where like reference numerals refer to identical or functionally similar elements throughout the separate views, are incorporated in and form part of the specification together with the detailed description below.

FIGS. 1a and 1b respectively show the back and the front of a T-shirt having temperature controlled multilayer portions according to the present invention.

FIG. 2 shows an enlarged view of a temperature controlled multilayer portion according to the present invention.

FIG. 3 shows a cross-section of a temperature controlled multilayer portions according to the present invention.

FIGS. 4a and 4b show a schematic view of a casing and a garment of the invention respectively before and after being coupled one to the other.

FIG. 5 shows a second embodiment of the invention applied to a t-shirt depicting both sides of the garment (front and back) and how the circuit runs along the fabric to provide the heat or the cold that the user needs.

FIG. 6 shows a detail of the thermoelectric device of the second embodiment of the invention inserted between the different layers of the garment.

FIG. 7 shows each part of the thermoelectric device of the second embodiment of the invention.

FIG. 8 shows the operation of the electronic circuit/wireless communication in the second embodiment of the invention.

### DESCRIPTION OF PREFERRED EMBODIMENTS

### First Embodiment

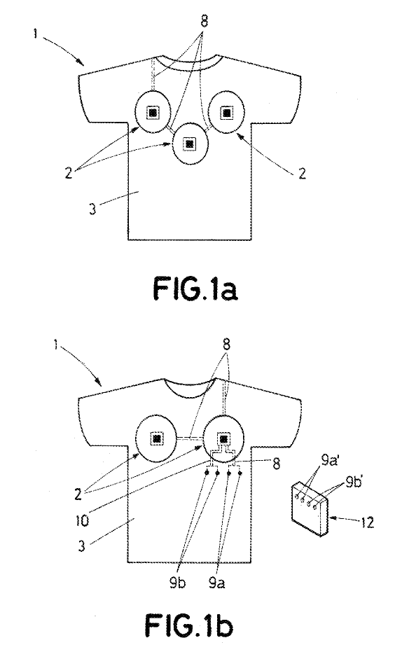

A first embodiment of the invention is disclosed with reference to FIGS. 1-4.

FIGS. 1A and 1B respectively show a back and front side of a T-shirt (1) having temperature controlled multilayer portions (2) according to the invention. More specifically, the T-shirt (1) shown here has three temperature controlled multilayer portions (2) at the upper back area and two temperature controlled multilayer portions (2) at the upper chest area.

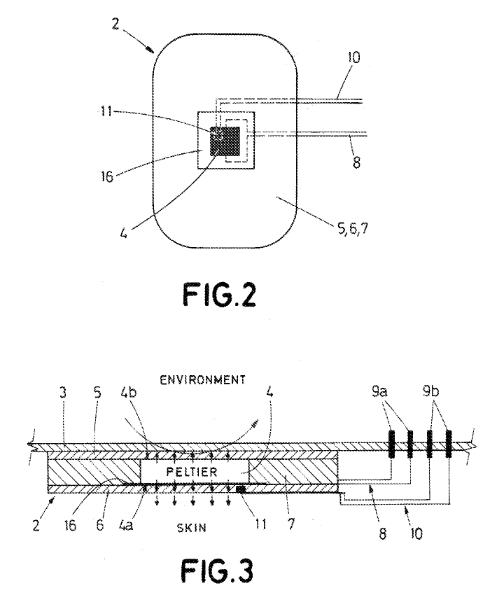

FIGS. 2 and 3 show the configuration of a temperature controlled multilayer portion (2) in detail. Each temperature controlled multilayer portion (2) comprises an essentially square thermoelectric device (4) having an inner planar side (4a) and an outer planar side (4b). The thermoelectric device (4) is attached to a flexible printed circuit board (16). The printed circuit board (16) is extremely flat, and therefore it does not affect the usability and flexibility of the T-shirt (1). As disclosed in more detail below, the function of the printed circuit board (16) is to provide a flat electrical connection between the first lead (8) and the contacts of the thermoelectric device (4).

The thermoelectric device (4) and the printed circuit board (16) are connected to a thermally conductive flexible inner layer (6) having a surface area considerably larger than the surface area of the thermoelectric device (4). Using a thermally conductive flexible inner layer (6), and correspondingly a thermally conductive flexible outer layer (5), having larger area than that of the thermoelectric device (4) increases the heat transfer capacity of the temperature controlled multilayer portion (2). In this embodiment, the thermally conductive flexible inner layer (6) is a tinned copper flexible foil. The connection between the inner planar side (4a) of the thermoelectric device (4) and the thermally conductive flexible inner layer (6) is carried out by welding using a tin welding material. With this configuration, heat generated at the inner planar side (4a) of the thermoelectric device is first transferred by conduction through the welded connection towards the thermally conductive flexible inner layer (6), and then transferred also by conduction towards the skin of the user which is in close contact therewith.

The outer planar side (4b) of the thermoelectric device (4) is welded to a thermally conductive flexible outer layer (5). In this embodiment, the thermally conductive flexible outer layer (5) is a piece of tinned copper thermal fabric. In turn, the thermally conductive flexible outer layer (5) is attached to an inner side of the T-shirt fabric (3). With this configuration, heat generated at the outer planar side (4b) of the thermoelectric device (4) is first transferred by conduction through the welded connection towards the thermally conductive flexible outer layer (5), and then transferred by convection through the T-shirt fabric (3) to the environment.

The temperature controlled multilayer portion (2) further comprises an intermediate layer (7) provided between the thermally conductive flexible inner layer (6) and the thermally conductive flexible outer layer (5) in the area not occupied by the thermoelectric device (4). The intermediate layer (7) is made of a thermally insulating material for preventing the exchange of heat between the thermally conductive flexible inner layer (6) and the thermally conductive flexible outer layer (5).

The flexible printed circuit board (16) comprises connections from an edge thereof to the input contacts of the thermoelectric device (4). A first lead (8) implemented as a ribbon-like flexible flat cable having two wires running along the inner side of the T-shirt fabric (3) connects the input contacts of all thermoelectric devices (4) with a first electrical connection means (9a), in this case a first pair of connectors (9a) protruding outwards through the T-shirt fabric (3). Note that the connectors (9a) are located in a portion of the T-shirt (1) separated from the areas where the temperature controlled multilayer portions (2) are located. The first pair of connectors (9a) is configured for electrical connection with an external power supply means (13).

The T-shirt (1) of the invention further comprises a temperature sensor (11) mechanically coupled to the thermally conductive flexible inner layer (6). The sensor (11) is connected by means of a second lead (10) also having two wires to a second electrical connection means (9b), in this case a second pair of connectors (9b) protruding outwards through the T-shirt fabric (3). This second pair of connectors (9b) is situated next to the first pair of connectors (9a). The second pair of connectors (9b) are configured for electrical connection with an external processing means (14). Note that, while not represented in the figures, the connectors (9a, 9b) may be directly crimped to the flexible printed circuit board (16), then passing through the intermediate layer (7), outer thermally conductive layer (5) and garment fabric (3), and finally protruding outwards.

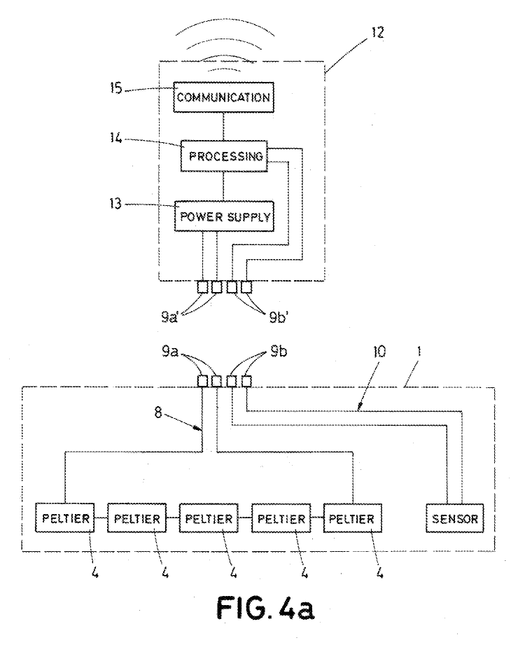

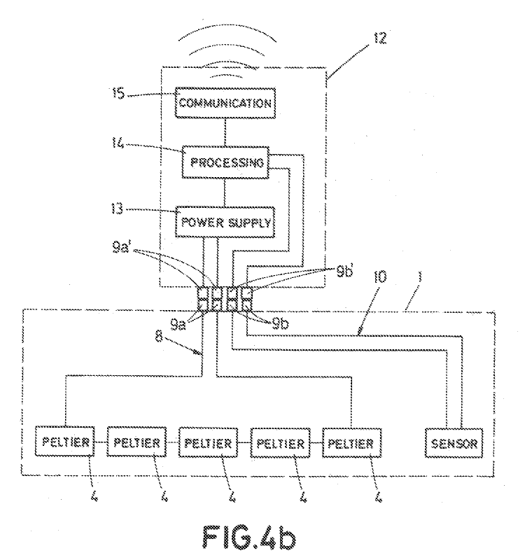

As shown in FIGS. 4A and 4B, the invention further comprises a casing (12) housing the power supply means (13), for example a battery, the processing means (14) and communication means (15). The processing means (14) is connected to the power supply means (13) and the communication means (15). Therefore, the processing means (14) can control the power supplied by the power supply means (13) and also communicate with an external device through the communication means (15).

The casing (12) is configured to be coupled to the T-shirt (1) of the invention by coupling the first and second pairs of connectors (9a, 9b) with respective mating connectors (9a′, 9b′) provided on a backside of the casing (12). Indeed, the first and second pair of connectors (9a, 9b) and the respective mating connectors (9a′, 9b′) are magnetically configured for creating an attraction force between them. The casing (12) can therefore be coupled to the T-shirt (1) of the invention in a very fast and convenient way.

Further to their magnetic coupling function, the connectors (9a, 9b) also have an electrical function. A first pair of mating connectors (9a′) are connected to the output of the power supply means (13), and a second pair of mating connectors (9b′) are connected to an input of the processing means (14). Thus, when the casing (12) is coupled to the T-shirt through the respective connectors (9a, 9b) and mating connectors (9a′, 9b′), as seen in FIG. 4B, automatically the thermoelectric devices (4) are connected to the power supply means (13) through the first lead (8) and the temperature sensor (11) is connected to the processing means (14) through the second lead (10). The thermoelectric devices (4) are connected in series to the first lead (8). This configuration is advantageous in that the current required for driving the thermoelectric devices (4) when connected in series is lower than the current required when connected in parallel. Consequently, a smaller power supply means (13) can be employed. FIGS. 4A and 4B show a schematic view of the T-shirt (1) and the casing (12) of the invention respectively disconnected and connected.

In an alternative embodiment of the invention not shown in the figures, a plurality of sensors could be provided in the T-shirt (1). For example, in addition to the temperature sensor (11), sensors such as a cardiac frequency sensor could be provided. The plurality of sensors would be connected to the flexible printed circuit board (16), where a dedicated circuitry would build a pulse train encoding the information provided by all sensors. Thus, information from several sensors could be transmitted by means of the second lead (10) to the processing means (14).

The user can use T-shirt (1) of the invention without the casing (12) for a certain period of time as a conventional T-shirt (1). The user may then feel hot, for example after playing a sport, and need to be cooled. He/she can then couple the casing (12) to the T-shirt (1) by means of the aforementioned magnetic connectors (9a, 9b) and mating connectors (9a′, 9b′). Once magnetically coupled, an electrical connection between the thermoelectric devices (4) and the power supply means (13) and between the temperature sensor (11) and the processing means (14) is provided. The thermoelectric devices (4) are supplied with a voltage having the desired polarity, i.e. a polarity causing the inner planar side (4a) of the thermoelectric devices (4) to get cool. The voltage applied by the power supply means (13) is controlled by the processing means (14) using the temperature of the thermally conductive flexible inner layer (6) provided by the temperature sensor (11) as a reference.

Further, the user can actively control the cooling power provided by the thermoelectric devices (4) by means of an app in his/her smartphone. Indeed, the communication means (15) allows the user to send commands to the processing means (14) for controlling the temperature control mode i.e. cooling or warming, as well as the voltage applied to the thermoelectric devices (4), i.e. the temperature of the thermoelectric devices (4). The communication can also take place in the opposite direction, such that the temperatures sensed by the temperature sensor (11) can be communicated to the smartphone such that the user can check the correct functioning of the T-shirt (1), e.g. by means of temperature graphs and the like.

### Second Embodiment

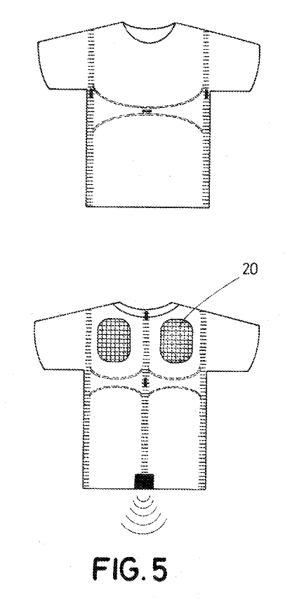

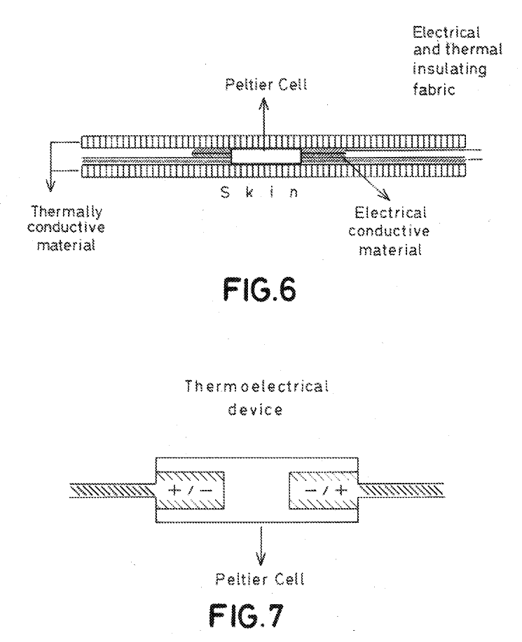

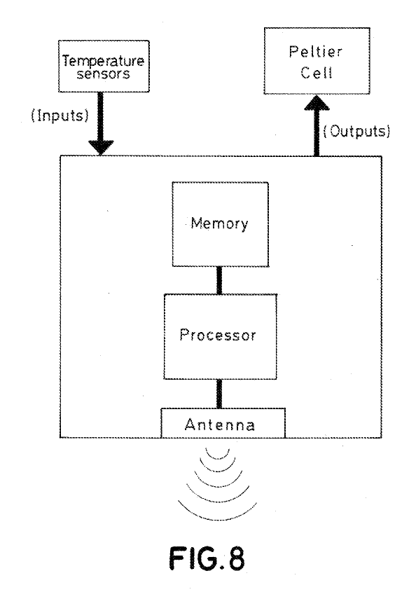

FIGS. 5-9 show a second embodiment of the invention where the thermoelectric devices are fed by solar panels (20) provided on the back of the T-shirt (1).

The system proposed is self-supplied by clean energy and totally wearable and adaptable to the body because of being made of thermal conductive material that allows a flexible mechanism that spreads the perfect temperature all over the body. The invention is adaptable to any kind of clothing for generic use, not only medical use, and consequently it has a great versatility. Embodiments of this invention relates to a wearable system for controlling the temperature of the body using the heat and cold generated both by a thermoelectric device, which is connected to a battery that can be fed by a battery or by small flexible solar panels. This device is controlled by an electronic circuit, which communicates via wireless to external devices such as smartphones, tablets or smartwatches.

This thermoelectric device are very small and require a low electrical power to work (around 0.7 volts). So we can include them in a lightweight garment and use them to provide cold or heat to users, without danger. Using a special fabric with high thermal conductivity, it can expand the temperature to a higher area of our body.

It is another object of the present invention to provide a wearable temperature regulator using thermoelectric technology that can generate heating/cooling to an area of the body by being incorporated into standard apparel such as t-shirts, pants, jackets, dresses, headwear, gloves, under garments, etc., that can be worn by the user, providing cooling or heating wherever the user goes.

Alternatively, the system may also provide cooling when it is too warm for a comfortable temperature. It will also insulate the user from the warmer outside temperature. A temperature control sensor may also be incorporated to prevent overheating or cooling during use. In fact, any device made of flexible material such as, for example, tents and similar enclosures may benefit from the incorporation of the present invention.

The system can be powered by high energy density, rechargeable batteries similar to those used in notebook computers or fuel cells. Several batteries may be placed into the pockets of a specially designed jacket, allowing extended usage and easy replacement. The system can also be powered by an alternative power source such as solar panels.

Finally, another preferred accomplishment of the invention also comprises an USB connection in order to extract information such as medical records and to enter information into the system.

1. Temperature controlled garment (1) comprising temperature controlled multilayer portions (2) attached to a garment fabric (3), characterized in that each said temperature controlled multilayer portion (2) comprises:
a thermoelectric device (4) having an inner planar side (4a) and an outer planar side (4b);
a thermally conductive flexible outer layer (5) welded to the outer planar side (4b) of the thermoelectric device (4); and
a thermally conductive flexible inner layer (6) welded to the inner planar side (4a) of the thermoelectric device (4).

2. Temperature controlled garment (1) according to claim 1, where the thermally conductive flexible outer layer (5) is a fabric comprising yarns made of a thermally conductive material.

3. Temperature controlled garment (1) according to claim 2, where the thermally conductive flexible outer layer (5) is a tinned copper thermal fabric.

4. Temperature controller garment (1) according to claim 1, where the thermally conductive flexible inner layer (6) is a foil made of a thermally conductive material.

5. Temperature controlled garment (1) according to claim 4, where the thermally conductive flexible inner layer (6) is a tinned copper flexible foil.

6. Temperature controlled garment (1) according to claim 1, where a surface of the thermally conductive flexible outer layer (5) and the thermally conductive flexible inner layer (6) is larger than a surface of the thermoelectric device (4).

7. Temperature controlled garment (1) according to claim 6, further comprising a thermally insulating intermediate layer (7) provided between the thermally conductive flexible outer layer (5) and the thermally conductive flexible inner layer (6) in an area of the temperature controlled multilayer portions (2) not occupied by the thermoelectric device (4).

8. Temperature controlled garment (1) according to claim 1, where the thermally conductive flexible outer layer (5) of each temperature controlled multilayer portion (2) is attached to an inner surface of the garment fabric (3).

9. Temperature controlled garment (1) according to claim 1, further comprising a first lead (8) electrically connecting the thermoelectric devices (4) with first electrical connection means (9a), where the first electrical connection means (9a) protrude outwards through the garment fabric (3) for electrical connection with a power supply means (13).

10. Temperature controlled garment (1) according to claim 1, further comprising a second lead (10) electrically connecting a temperature sensor (11) in thermal contact with the thermally conductive inner layer (6) with second electrical connection means (9b), where the second electrical connection means (9b) protrude outwards through the garment fabric (3) for electrical connection with a processing means (14) connected with the power supply means (13).

11. Temperature controlled garment (1) according to claim 10, where the first and second electrical connection means (9a, 9b) are provided with coupling means configured for coupling to a casing (12) containing the power supply means (13) and the processing means (14).

12. Temperature controlled garment (1) according to claim 10, where the first and second electrical connection means (9a, 9b) are located in an area of the garment (1) other than in the temperature controlled multilayer portions (2).

13. Temperature controller garment (1) according to claim 12, where the first and second connection means (9a, 9b) having coupling means are respective pairs of connectors made of a magnetic and electrically conductive material configured for coupling to magnetically mating and electrically conductive connectors (9a′, 9b′) provided in the casing (12).

14. Temperature controlled garment (1) according to claim 13, further comprising communication means (15) provided in the casing (12) and connected with the processing means (14) for receiving commands in connection with the voltage and polarity applied to the thermoelectric devices (4).
